(19) United States
(12) Patent Application Publication
(10) Pub. No.: US 2026/0099789 A1
(43) Pub. Date: Apr. 9, 2026

(54) ACTION FEATURE GENERATION FOR METHODOLOGY ENFORCEMENT AND VALIDATION

(71) Applicant: International Business Machines Corporation, Armonk, NY (US)

(72) Inventors: Jesus Manuel Olivera, New York, NY (US); Ravinder Singh Kang, Fort Lauderdale, FL (US); Yeun ji Jung, Long Island City, NY (US); Thomas Giavatto, Beacon, NY (US)

(21) Appl. No.: 18/906,814

(22) Filed: Oct. 4, 2024

(51) Int. Cl. G06Q 10/0631

(52) U.S. Cl. CPC G06Q 10/06316

(57) ABSTRACT

A system includes a processor that executes computer executable components stored in a memory. The computer executable components can comprise an analysis component that analyzes a policy document. The computer executable components further comprise a policy dataframe component that generates a policy dataframe corresponding to attributes of the analyzed policy document. The computer executable components further comprise an enforcement component that determines a set of tasks to be performed in order to ensure compliance with the policy document.

### BACKGROUND

The subject disclosure relates to automating the interpretation of policy requirements, e.g., action feature generation for methodology enforcement and validation.

The large volume of regulatory requirements presents a significant challenge for organizations across all industries. With each passing year, the regulatory landscape becomes increasingly complex and extensive, demanding meticulous attention to compliance from businesses. This influx of regulations force organizations to allocate substantial resources towards understanding, implementing, and adhering to these requirements. As a result, companies are compelled to adopt more creative approaches to navigate through the intricacies of compliance, leveraging technology, automation, and innovative strategies to streamline processes and ensure adherence across all lines of business.

Failure to meet regulatory compliance poses substantial risks for large organizations, encompassing legal, financial, and reputational consequences. Non-compliance can lead to fines, legal proceedings, and regulatory sanctions, draining resources and damaging profitability for organizations. Moreover, reputational damage stemming from noncompliance incidents can erode customer trust and investor confidence, jeopardizing long-term sustainability and growth prospects.

The imperative for organizations to diligently adhere to regulatory requirements has never been greater, necessitating proactive measures to mitigate risks and ensure operational resilience.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate action feature generation for methodology enforcement and validation are provided.

According to an embodiment, a system can comprise a processor that executes computer executable components stored in memory. The computer executable components can comprise an analysis component that analyzes a policy document. The computer executable components comprise a policy dataframe component that generates a policy dataframe corresponding to attributes of the analyzed policy document. The computer executable components further comprise an enforcement component that determines a set of tasks to be performed in order to ensure compliance with the policy document.

According to another embodiment, a computer-implemented method can comprise analyzing a policy document. The computer-implemented method can further comprise generating a policy dataframe corresponding to attributes of the analyzed policy document. The computer-implemented method can further comprise determining a set of tasks to be performed in order to ensure compliance with the policy document.

According to another embodiment, a computer program product comprising a computer readable storage medium having program instructions embodied therewith, the program instructions executable by a processor to cause the processor to analyze, by the processor, a policy document. The program instructions can also cause the processor to generate, by the processor, a policy dataframe corresponding to attributes of the analyzed policy document. The program instructions can also cause the processor to determine, by the processor, a set of tasks to be performed in order to ensure compliance with the policy document.

### BRIEF DESCRIPTION OF THE DRAWINGS

FIGS. 1 and 2 illustrate example systems that can facilitate action feature generation for methodology enforcement and validation in accordance with some embodiments described herein.

FIGS. 3, 4, and 5 illustrate example action feature flow diagrams in accordance with some embodiments described herein.

FIG. 6 illustrates an example policy-to-action-feature flow diagram in accordance with some embodiments described herein.

FIG. 7 illustrates an example policy enforcement flow diagram in accordance with some embodiments described herein.

FIG. 8 illustrates an example policy validation flow diagram in accordance with some embodiments described herein.

FIG. 9 illustrates an example action feature flow diagrams in accordance with some embodiments described herein.

FIG. 10 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Organizations across various industries are increasingly facing the challenge of navigating a rapidly evolving and expansive regulatory environment. As the volume of regulations continues to grow year by year, companies must dedicate substantial resources to understanding, interpreting, and implementing compliance measures. These regulatory frameworks encompass a wide array of operational areas such as data protection, financial reporting, environmental sustainability, and workplace safety. The sheer breadth and depth of regulatory requirements mean that organizations can no longer rely on traditional, manual processes to ensure compliance. Instead, there is a critical need for innovative, efficient, and scalable solutions that help businesses streamline compliance efforts and mitigate risks. Failure to meet these obligations can result in devastating legal, financial, and reputational consequences, which makes proactive, technology-driven solutions indispensable in today's complex regulatory landscape.

The risks associated with non-compliance are both immediate and long-term. In the short term, non-compliance exposes organizations to fines, sanctions, and legal action, leading to significant financial burdens. Regulatory bodies are becoming more stringent in their enforcement, and businesses that fail to adhere to their requirements are met with severe penalties. Beyond the financial implications, non-compliance can damage a company's reputation, eroding trust among customers, stakeholders, and investors. In an era where consumers are increasingly concerned with ethical business practices and transparency, reputational damage can undermine a company's ability to attract and retain customers, as well as secure investment. Moreover, non-compliance jeopardizes operational resilience by disrupting processes and exposing companies to regulatory uncertainties, which can hinder long-term growth and sustainability.

There is a need for a sophisticated approach to compliance management. Relying on manual interpretation of regulatory documents and policy requirements is no longer practical for large organizations that need to ensure consistency and accuracy across all business lines. To overcome these challenges, the solution proposed herein centers on automating the interpretation of policy requirements through the generation of action features that can be directly applied to compliance methodologies. This automation addresses the challenges of complexity and scale by transforming the manual process of interpreting policies into a streamlined, technology-driven workflow. Breaking down policy requirements into actionable features allows for a more precise and comprehensive understanding of what each regulation entails, and for the implementation of appropriate controls, thereby ensuring compliance across a greater range of operational areas.

In relation to action feature generation for methodology enforcement and validation, embodiments of the present disclosure produce a solution to one or more of these problems. These embodiments may solve such problems by analyzing a policy document and generating a policy dataframe corresponding to attributes of the analyzed policy document. These embodiments may also include determining a set of tasks to be performed in order to ensure compliance with the policy document.

Systems and methods described herein pertain to programmatically generating a framework for enforcing and validating policy requirements. Policy documents are taken as inputs. Unstructured text of the policy documents is transformed into a structured, tabular format that can be processed and analyzed. The policy is parsed and organized into rows and columns, where each component of a given policy (e.g., individual requirements, rules, clauses, or other relevant elements) is represented in a form that a system can easily interact with. This structured format allows for easier automation, analysis, and enforcement of compliance requirements. Specific policy requirements and corresponding action-features are then extracted from the policy documents. More specifically, key elements of the policy documents (e.g., rules, obligations, conditions, actions, etc.) are identified and translated into actionable components that can be enforced programmatically. For each policy requirement, one or more action-features are generated. The action-features are then executed to ensure compliance with the policy requirements. Compliance with the policy requirements is then validated by mapping (e.g. tracing) outputs and actions back to their originating policy requirements.

According to an embodiment, a system can comprise a processor that executes computer executable components stored in memory. The computer executable components can comprise an analysis component that analyzes a policy document. The computer executable components can further comprise a policy dataframe component that generates a policy dataframe corresponding to attributes of the analyzed policy document. The computer executable components may further comprise an enforcement component that determines a set of tasks to be performed in order to ensure compliance with the policy document.

In some embodiments, the system further comprises a performance component that performs the set of tasks; and a validation component that validates compliance with the policy.

According to some embodiments, the attributes of the analyzed policy document further comprise at least one of: an area of focus of the policy, a scope of the policy, a summary of the policy, and specific requirements of the at least one policy.

In some embodiments, the policy dataframe component utilizes a large language model to identify the attributes.

In some embodiments, the system further comprises a training component that trains an artificial intelligence model to automatically generate the policy data frame and automatically perform the set of tasks.

According to some embodiments, the enforcement component ensures compliance by: breaking down a final output, mapping the final output to the attributes, and assessing compliance with the policy.

In some embodiments, the system can further comprise an artificial intelligence component that trains a large language model to identify the attributes. According to an embodiment, the artificial intelligence component uses the attributes to assess policy compliance.

In some embodiments, in response to a determination that performance of the set of tasks fails to result in policy compliance, the enforcement component identifies a new set of tasks to be performed in order to ensure policy compliance.

Advantages of this system may include faster interpretation and implementation of regulatory policy requirements, greater scalability across operations, minimized opportunity for human error, greater standardization of compliance practices, continuous monitoring and validation, real-time adaptation to regulatory changes, and lower compliance costs.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

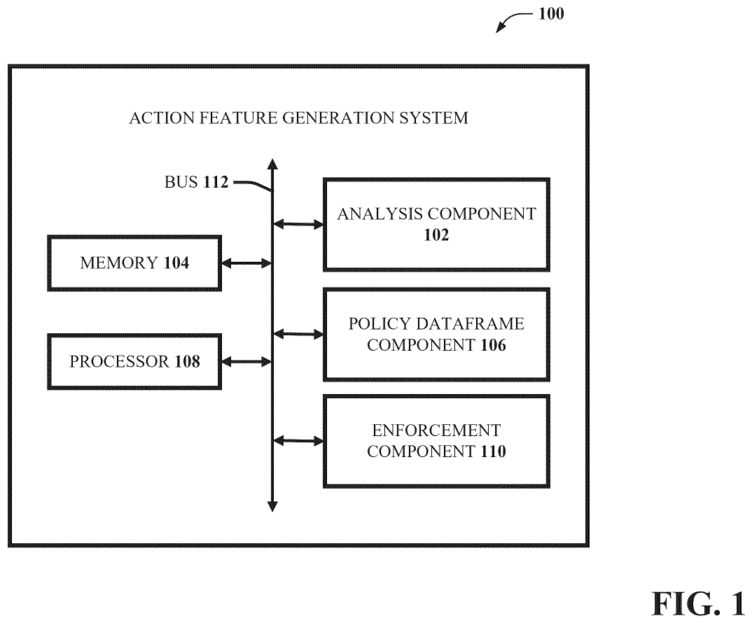

FIG. 1 illustrates an example system 100 for facilitating action feature generation for methodology enforcement and validation. The system 100 uses an analysis component 102, a policy dataframe component 106, and an enforcement component 110. The analysis component 102 analyzes a policy document. The policy dataframe component 106 generates a policy dataframe corresponding to attributes of the analyzed policy document. The enforcement component 110 determines a set of tasks to be performed in order to ensure compliance with the policy document.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by the one or more machines (e.g., computers, computing devices, virtual machines, etc.) can cause the machines to perform the operations described. System 100 may comprise an analysis component 102, a memory 104, a policy dataframe component 106, a processor 108, an enforcement component 110, and a system bus 112.

The system 100 and/or the components of the system 100 may use hardware and/or software to solve problems that are highly technical in nature. The system 100 solves problems that are not abstract and that cannot be performed as a set of mental acts by a human. Further, some of the processes may be performed by specialized computers for carrying out defined tasks related to action feature generation for methodology enforcement and validation. The system 100 and/or components of the system 100 may be employed to solve new problems that arise through advancements in technologies. The system 100 may provide technical improvements action feature generation for methodology enforcement and validation by increasing speed of interpretation and implementation of regulatory policy requirements, enhancing scalability across operations, minimizing opportunity for human error, increasing standardization of compliance practices, providing continuous monitoring and validation, adapting in real-time to regulatory changes, and lowering compliance costs.

The system 100 may include a processor 108. The processor 108 may execute a component or subcomponent associated with the system 100. Components or subcomponents associated with the system 100 may include one or more machine readable, writable, and/or executable instructions. In some embodiments, the system 100 may include a memory 104, and the memory 104 may store one or more components and/or subcomponents associated with the system 100. In some embodiments, the processor 108 may execute a component stored in the memory 104.

In some embodiments, the system 100 may include a computer-readable memory 104 that may be operably connected to the processor 108. The memory 104 may store computer-executable instructions that, upon execution by the processor 108, may cause the processor 108 and/or one or more other components of the system 100 (e.g., the analysis component 102, the policy dataframe component 106, and/or the enforcement component 110) to perform one or more actions. In some embodiments, the memory 104 may store computer-executable components (e.g., the analysis component 102, the policy dataframe component 106, and/or the enforcement component 110).

The system 100 and/or a component thereof as described herein may be communicatively, electrically, operatively, optically, and/or otherwise coupled to one another via a bus 112. The bus 112 may include one or more of a memory bus, memory controller, peripheral bus, external bus, local bus, and/or another type of bus that may employ one or more bus architectures. In some embodiments, the system 100 may be coupled (e.g., communicatively, electrically, operatively, optically, and/or the like) to one or more external systems (e.g., an electrical output production system, one or more output targets, an output target controller, and/or the like). In some embodiments, the system 100 may be coupled to one or more external sources, and/or devices (e.g., classical computing devices, communication devices, and/or like devices), such as via a network. In some embodiments, one or more of the components of the system 100 may reside in the cloud and/or locally in a local computing environment (e.g., at one or more specified locations).

In addition to the processor 108 and/or the memory 104 described above, the system 100 may include one or more computer and/or machine readable, writable, and/or executable components and/or instructions. When executed by the processor 108, these components and/or instructions may enable performance of one or more operations defined by the component(s) and/or instruction(s).

In various embodiments, the analysis component 102 analyzes a policy document. In some embodiments, the analysis component 102 identifies features of policy requirements to be used in a later stage of policy enforcement. According to some embodiments, the analysis component 102 analyzes at least one of: an area of focus of a policy, a scope of a policy, a summary of a policy, and specific requirements of an at least one policy. The policy dataframe component 106 can generate a policy dataframe corresponding to attributes of the analyzed policy document. In some embodiments, the attributes of the analyzed policy document comprise at least one of: an area of focus of a policy, a scope of a policy, a summary of a policy, and specific requirements of an at least one policy. In some embodiments, the policy dataframe component 106 utilizes a large language model to identify the attributes. The enforcement component 110 can determine a set of tasks to be performed in order to ensure compliance with the policy document. According to some embodiments, the enforcement component ensures compliance by: breaking down a final output, mapping the final output to the attributes, and assessing compliance with the policy. In some embodiments, in response to a determination that performance of the set of tasks fails to result in policy compliance, the enforcement component identifies a new set of tasks to be performed in order to ensure policy compliance.

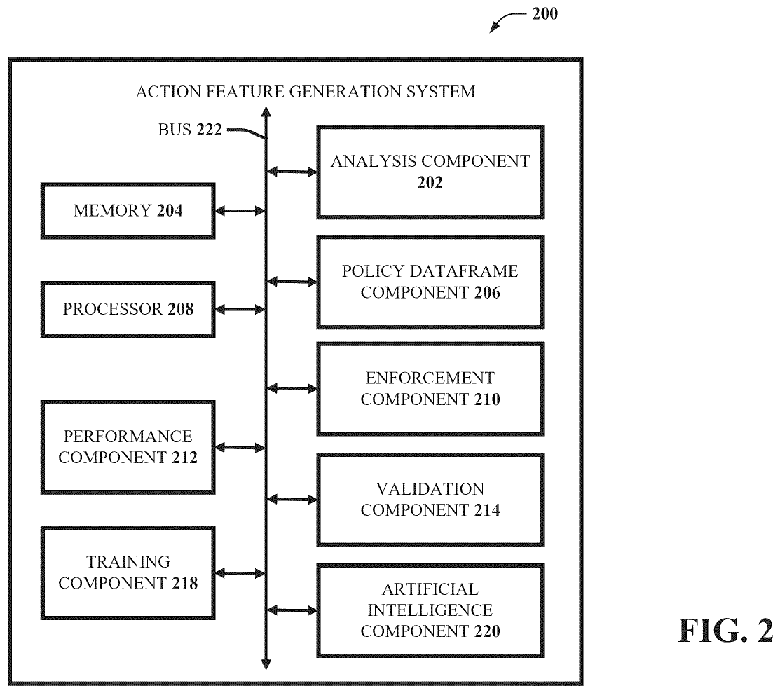

FIG. 2 illustrates an example system 200 that can facilitate action feature generation for methodology enforcement and validation. The system 200 uses an analysis component 202, a policy dataframe component 206, an enforcement component 210, a performance component 212, a validation component 214, a training component 216, and an artificial intelligence component 220. The system 200 may also include a memory 204, a processor 208, and a system bus 222. Description of like components has been omitted for the sake of brevity.

In various embodiments, the analysis component 202 analyzes a policy document. The policy dataframe component 206 can generate a policy dataframe corresponding to attributes of the analyzed policy document. Enforcement component 210 can determine a set of tasks to be performed in order to ensure compliance with the policy document. According to some embodiments, the enforcement component 210 ensures compliance by breaking down a final output, mapping the final output to the attributes, and assessing compliance with the policy. In some embodiments, in response to a determination that performance of the set of tasks fails to result in policy compliance, the enforcement component 210 identifies a new set of tasks to be performed in order to ensure policy compliance. In various embodiments, performance component 212 performs the set of tasks. The validation component 214 can validate compliance with the policy. In various embodiments, training component 218 trains an artificial intelligence model to automatically generate the policy data frame and automatically perform the set of tasks. According to some embodiments, the artificial intelligence component 218 uses the attributes to assess policy compliance.

The systems and/or devices are described herein with respect to interaction between one or more components. Such systems and/or components may include the components and/or sub-components specified therein, one or more of the specified components and/or sub-components, and/or additional components. Sub-components may be implemented as components communicatively coupled to other components rather than included within parent components. One or more components and/or sub-components may be combined into a single component providing aggregate functionality. The components may interact with one or more other components not specifically described herein for the sake of brevity but known by those of skill in the art.

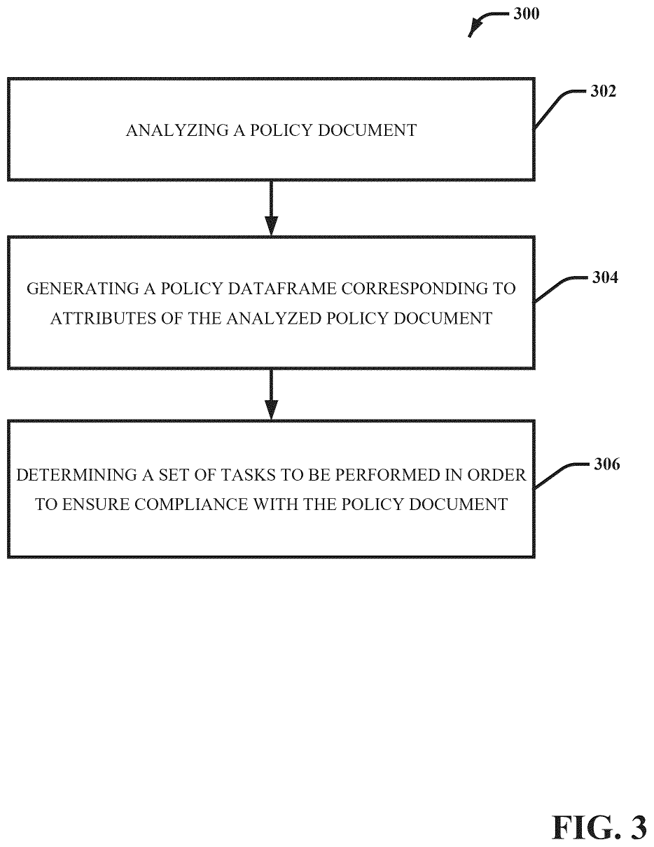

FIG. 3 illustrates an example action feature generation diagram 300 that can facilitate action feature generation for methodology enforcement and validation. In some embodiments, a policy document is analyzed. In various embodiments, a policy dataframe corresponding to attributes of the analyzed policy document is generated. In some embodiments, a set of tasks to be performed in order to ensure compliance with the policy document is determined.

The action feature generation diagram 300 starts by analyzing 302 a policy document. The action feature generation diagram 300 continues by generating 304 a policy dataframe corresponding to attributes of the analyzed policy document. The action feature generation diagram 300 continues by determining 306 a set of tasks to be performed in order to ensure compliance with the policy document.

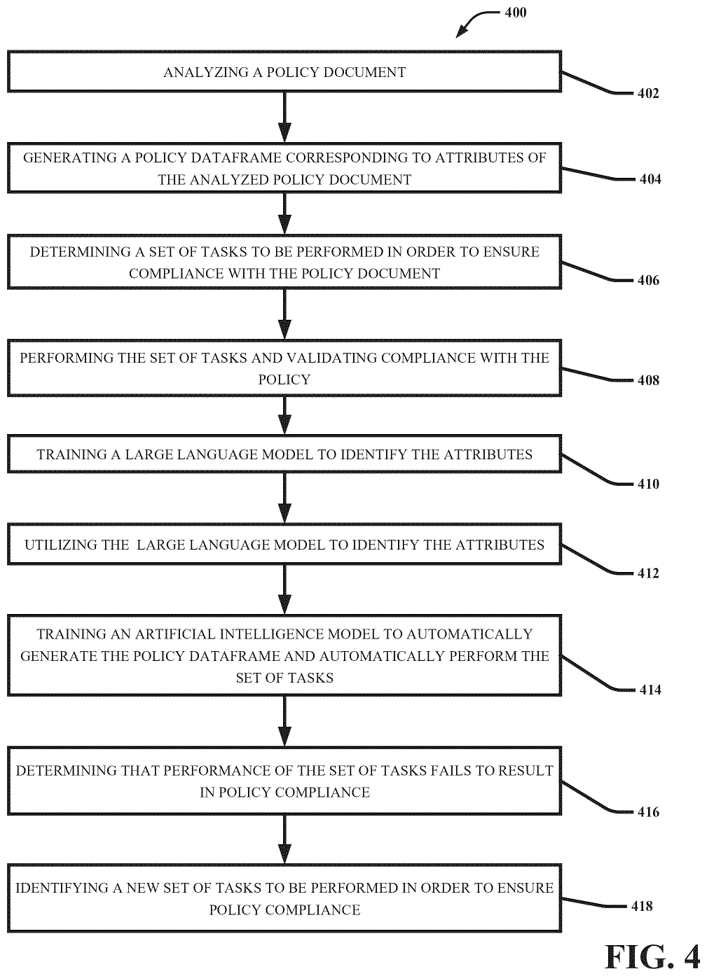

FIG. 4 illustrates an example action feature generation diagram 400 that can facilitate action feature generation for methodology enforcement and validation. In some embodiments, a policy document is analyzed. In various embodiments, a policy dataframe corresponding to attributes of the analyzed policy document is generated. In some embodiments, a set of tasks to be performed in order to ensure compliance with the policy document is determined. In various embodiments, the set of tasks is performed. In some embodiments, compliance with the policy is validated. In various embodiments, a large language model is trained to identify the attributes. In some embodiments, the large language model is utilized to identify the attributes. In some embodiments, an artificial intelligence model is trained to automatically generate the policy, and to automatically perform the set of tasks. In various embodiments, a new set of tasks to be performed in order to ensure policy compliance is identified.

The action feature generation diagram 400 starts by analyzing 402 a policy document. The action feature generation diagram 400 continues by generating 404 a policy dataframe corresponding to attributes of the analyzed policy document. The action feature generation diagram 400 continues by determining 406 a set of tasks to be performed in order to ensure compliance with the policy document. The action feature generation diagram 400 continues by performing 408 the set of tasks and validating compliance with the policy. The action feature generation diagram 400 continues by training 410 a large language model to identify the attributes. The action feature generation diagram 400 continues by utilizing 412 the large language model to identify the attributes. The action feature generation diagram 400 continues by training 414 an artificial intelligence model to automatically generate the policy dataframe and automatically perform the set of tasks. The action feature generation diagram 400 continues by determining 416 that performance of the set of tasks fails to result in policy compliance. The action feature generation diagram 400 continues by identifying 418 a new set of tasks to be performed in order to ensure policy compliance.

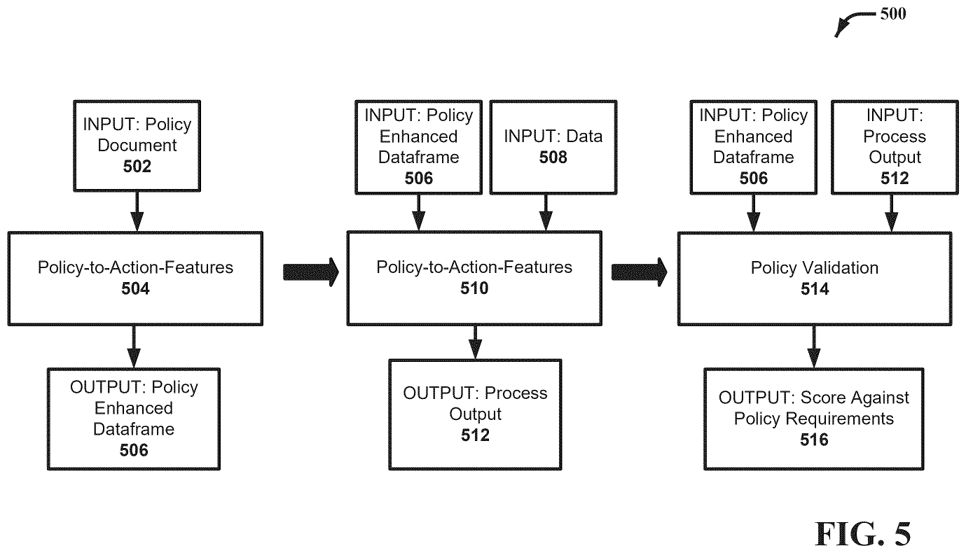

FIG. 5 illustrates an illustrates an example action feature generation flow diagram 500 in accordance with some embodiments described herein. The action feature generation flow diagram 500 starts by receiving as an input a policy document 502. The policy document 502 can be an unstructured source text containing regulatory, legal, or internal guidelines and requirements. This document could be from a government agency, regulatory body, or internal corporate governance rules. Examples of policy documents include a financial regulatory document mandating transaction reporting standards, a cybersecurity policy requiring data encryption and user access control, and a healthcare regulation requiring patient data privacy protections. The policy document may be unstructured, meaning it is written in natural language, perhaps with complex clauses, legal jargon, and specific obligations. The policy document may be multifaceted, containing various types of information, including rules, exceptions, timelines, conditions, and penalties for non-compliance.

The action feature generation flow diagram 500 continues at 504 by processing the policy to action-features. This is the core processing step, where the policy document is parsed and transformed into action-features (e.g., specific, actionable components that can be executed by a system). The policy text can be parsed using techniques like Natural Language Processing (NLP). Key clauses and components from the policy are isolated. Once the policy requirements are extracted, they are translated into action-features. Each policy requirement can be associated with an at least one corresponding action-feature, which dictates how a system should enforce a given requirement. Each action-feature can be tied back to a specific requirement in the policy, thereby ensuring traceability, allowing a system to enforce compliance actions programmatically and to automate the validation of those actions.

The action feature generation flow diagram 500 continues at 506 by outputting a policy enhanced Dataframe. A Dataframe is a structured, tabular format that represents the policy requirements and corresponding action-features in a machine-readable and analyzable way. The Dataframe may be enhanced with all relevant compliance information derived from the policy. Each row in the Dataframe can represent a specific policy requirement or clause that was extracted during the previous step 504. The columns of the Dataframe can represent various attributes of each policy requirement and its corresponding action-features. The policy-enhanced Dataframe can serve as a central control structure for automating compliance enforcement. The policy-enhanced Dataframe can integrate both the policy rules and a system's enforcement mechanisms into a single format, which in turn can be fed into automated workflows, monitoring systems, or compliance auditing tools. The Dataframe can be queried and analyzed by automated systems to: continuously check compliance (e.g., verify whether certain rules are being followed in real time), automatically trigger actions based on detected events (e.g., sending reports, generating alerts), and audit compliance by tracing actions back to policy requirements.

The action feature generation flow diagram 500 continues by receiving as inputs policy enhanced dataframe 506 and data 508. Here, the output from the previous step, policy enhanced dataframe 506, is combined with real-world operational data 508 that an organization generates or handles (e.g., transaction records, logs, user activity, financial data, communications data, etc.). This combination allows a system to apply policy-driven controls and validations to ensure that an organization's operations comply with regulatory requirements.

The action feature generation flow diagram 500 continues by executing 510 the action-features in real time on the operational data 508. Here, each policy requirement (via action-features in the Dataframe) is taken and applied to the relevant operational data 508. Each action-feature within the Dataframe has been designed to enforce a specific policy requirement. Now, these features are executed on the data. The action-features can act as real-time controls over the data 508, ensuring ensures that operations happening in an organization (such as transactions, data transfers, or system access) are continuously checked against policy requirements.

The action feature generation flow diagram 500 continues by outputting process output 512. The process output can be the result of applying the policy-enhanced Dataframe506's action-features 510 to the operational data 508. The output 512 can represent compliant results that are in line with the policy requirements. The output 512 could take various forms, depending on an organization's needs and the specific policies being enforced.

action feature generation flow diagram 500 continues by inputting policy enhanced Dataframe 506 and process output 512. The actual results from the process output 512 to the policy requirements represented in the policy-enhanced Dataframe 506. This allows for a formal validation of how well an organization's operations complied with the original policy 502. Thus, the policy-enhanced Dataframe 506 may serve as a ground truth for compliance requirements, while the process output can represent the actual actions and results from a system after the policy rules 502 were applied to the data 508. Policy validation 514 evaluates how well the process outputs 512 meet the policy requirements 502. This is essentially the “reverse” of the earlier enforcement steps, where now a system can check whether the actions taken were correct and compliant. Policy validation 514 may be accomplished by mapping the results (process output 512) back to the original policy clauses in the Dataframe 506. For each policy requirement in the Dataframe 506, there may be validation criteria—specific conditions that must be met for the process output 512 to be considered compliant. These criteria may include: timing, completeness, correctness, etc.

The action feature generation flow diagram 500 continues by outputting a score 516 against the policy requirements. The score 516 can represent a quantitative and qualitative assessment of how well the process outputs 512 adhered to the original policy requirements. The score 516 can be a formal measure of compliance. The score 516 can be assigned based on how closely the process outputs 512 meet the validation criteria outlined in the policy-enhanced Dataframe 506. Score 516 can represent a percentage of how many of the policy requirements were fully met. Alternatively, some policy requirements may be more critical than others, and scores can be weighted accordingly. In another embodiment, each requirement might be validated with a simple pass or fail.

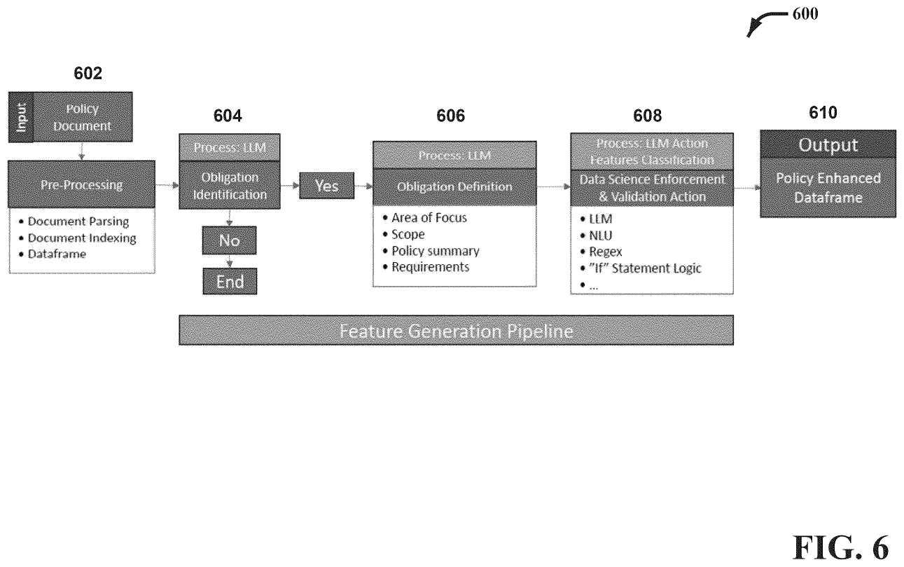

FIG. 6 illustrates an example policy-to-action-feature flow diagram 600 in accordance with some embodiments described herein. The policy-to-action-feature flow diagram 600 starts by inputting and pre-processing 602 a policy document. Policy document 602 is described with reference to the policy document 502 of flow diagram 500. Repeated description of like elements is omitted for the sake of brevity. Pre-processing the policy document can involve a series of steps that transform the raw text of the document into a structured format that can be easily analyzed, understood, and utilized within a compliance automation system. Pre-processing can include document parsing, document indexing, and Dataframe conversion. Document parsing refers to the process of analyzing the text of the policy document to break it down into manageable components or elements. This may include using natural language processing (NLP) techniques to extract relevant sections, clauses, and requirements from the document. Document indexing may involve creating an organized reference system for the parsed elements of the policy document, thereby allowing for quick retrieval and searching of relevant information. Dataframe conversion can refer to transforming the parsed and indexed policy elements into a structured Dataframe format.

The policy-to-action-feature flow diagram 600 continues at 604 by identifying obligations contained within the policy document. If no obligation is identified, the process ends. If one or more obligations are identified, the process continues to 606. At 606, the one or more obligations of the policy document are defined. The definition may include one or more of an area of focus, a scope of the policy obligation a summary of the policy obligation, and specific requirements of the policy obligation. The policy-to-action-feature flow diagram 600 continues at 608 by applying data science enforcement and validation action. Data science methods may be used to classify action features from policy documents, implement those features to ensure compliance, and validate that the actions taken are correct and effective. The policy-to-action-feature flow diagram 600 continues at 610 by outputting a policy enhanced Dataframe. The policy enhanced Dataframe of 610 references back to the policy enhanced Dataframe 506 of diagram 500. Repeated description of like elements has been omitted for the sake of brevity.

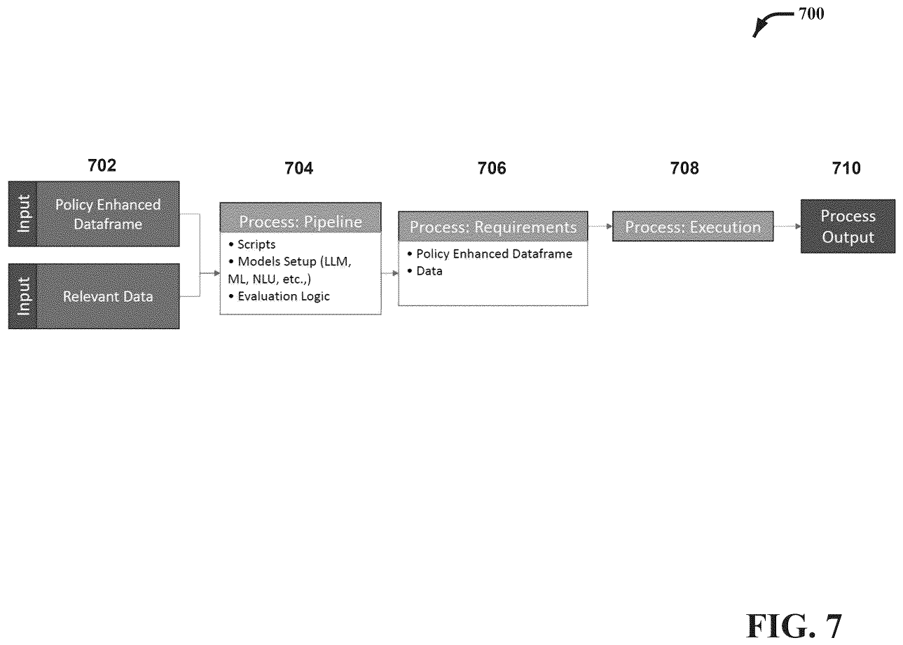

FIG. 7 illustrates an example policy enforcement flow diagram in accordance with some embodiments described herein. The policy enforcement flow diagram 700 starts with inputting 702 a policy enhanced Dataframe (for example, the policy enhanced Dataframe 506 of FIG. 5) and relevant data. Relevant data may include information or datasets required to enforce and validate compliance with policy requirements. Relevant data may further include actual operational data, metadata, and external data.

The policy enforcement flow diagram 700 continues to Process: Pipeline 704, which represents the configuration and orchestration of any technical components to process the inputs. Scripts may be used to handle specific operations such as parsing, data transformation, feature extraction, and applying policy actions to data. Various models (including large language models (LLMs), machine learning (ML) models, and natural language understanding (NLU) models may be applied to the data. LLMs may be used to interpret text-based policy documents and extract actionable features. ML models may be applied for anomaly detection, classification, and pattern recognition related to compliance activities. NLU models may be used to interpret, categorize, and derive meaning from text inputs, such as policy clauses or unstructured data. Evaluation logic may be used to define how a models'outputs are evaluated against policy requirements, such as by defining thresholds, conditions, or classifications. Thus, Process: Pipeline 704 can establish a necessary environment for running and evaluating policy compliance.

The policy enforcement flow diagram 700 continues to Process: Requirements 706, wherein the policy enhanced Dataframe and the relevant data are actively processed through the system to evaluate compliance. This step focuses on applying (e.g., matching) the policy requirements and rules to the data. Thus, Process: Requirements 706 enables a system to actively map each data point to corresponding policy action-features and to evaluate whether each data point complies with or violates policy rules.

The policy enforcement flow diagram 700 continues to Process: Execution 708, wherein a system takes the results from the previous steps and executes compliance actions based on the evaluation of the data against the policy. Execution can involve performing actions based on whether data meets or violates policy requirements, such as generating a compliance report or submitting required information to regulators, sending alerts or notifications, initiating corrective workflows, etc.

The policy enforcement flow diagram 700 continues to Process Output 710, which involves generation of a process output. The process output can include a compliance report, an alert or notification, audit logs, and remediation workflows.

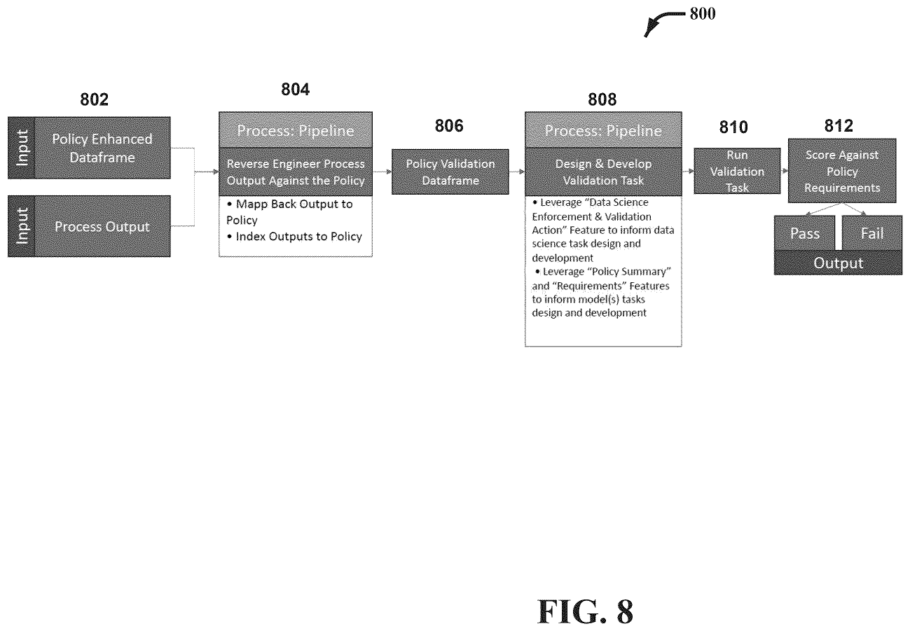

FIG. 8 illustrates an example policy validation flow diagram in accordance with some embodiments described herein. The policy validation flow diagram 800 begins with inputting 802 a policy enhanced Dataframe (for example, the policy enhanced Dataframe 506 of FIG. 5) and Process Output (for example, the Process Output 712 of FIG. 7). The policy validation flow diagram 800 continues to Process: Pipeline 804, wherein the Process Output is reverse engineered against the policy. The policy validation flow diagram 800 continues to process validation Dataframe 806, wherein a system validates whether the process output meets original policy requirements. The process validation Dataframe 806 is designed to structure and organize the results of the reverse-engineering process. The policy validation flow diagram 800 continues to Process: Pipeline 808, wherein a validation task is designed and developed. Process: Pipeline 808 can leverage a “data science enforcement and validation action” feature to inform data science tasks and development. Process: Pipeline 808 can leverage a “policy summary” feature and a “requirements” feature to inform model(s) tasks design and development. Process: Pipeline 808 can design and development validation tasks that can be executed to ensure final outputs (e.g., reports, alerts, actions) align with policy action-features. The validation tasks can be automated, structured steps to check, cross-reference, and verify whether outputs meet compliance goals defined by the policy enhanced dataframe. This step can involve creating specific logic, scripts, or workflows used to validate outputs during the compliance enforcement process. The policy validation flow diagram 800 continues to run validation task 810, wherein the validation tasks that were designed and developed in the previous step are executed to validate the compliance of the process outputs against the original policy requirements. The policy validation flow diagram 800 continues to output score against policy requirements 812, wherein a compliance score can be generated based on the results of the validation tasks. The score can represent how well process outputs align with original policy requirements and action-features. The output score can provide a quantitative and qualitative assessment of compliance, which can be used to understand the level of adherence to regulatory or internal policies. The output score can be a “pass/fail”assessment.

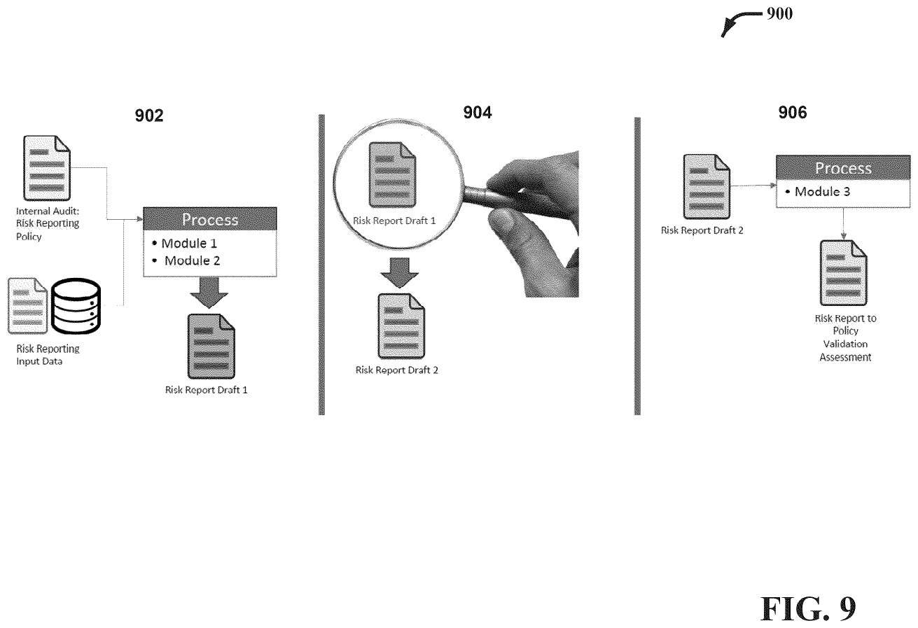

FIG. 9 illustrates an example action feature flow diagrams in accordance with some embodiments described herein. The action feature flow diagram 900 begins at 902 with inputting a policy document (the risk report policy) and relevant data in order to generate a first risk report document. The action feature flow diagram 900 continues to 904, wherein a user reviews the first risk report document and makes changes to the document in order to develop a second risk report document. The action feature flow diagram 900 then continues to 906, wherein the second risk report document was assessed by a system (such as the system 100 of FIG. 1) in order to review final outputs against the policy document, thereby ensuring compliance with relevant policies.

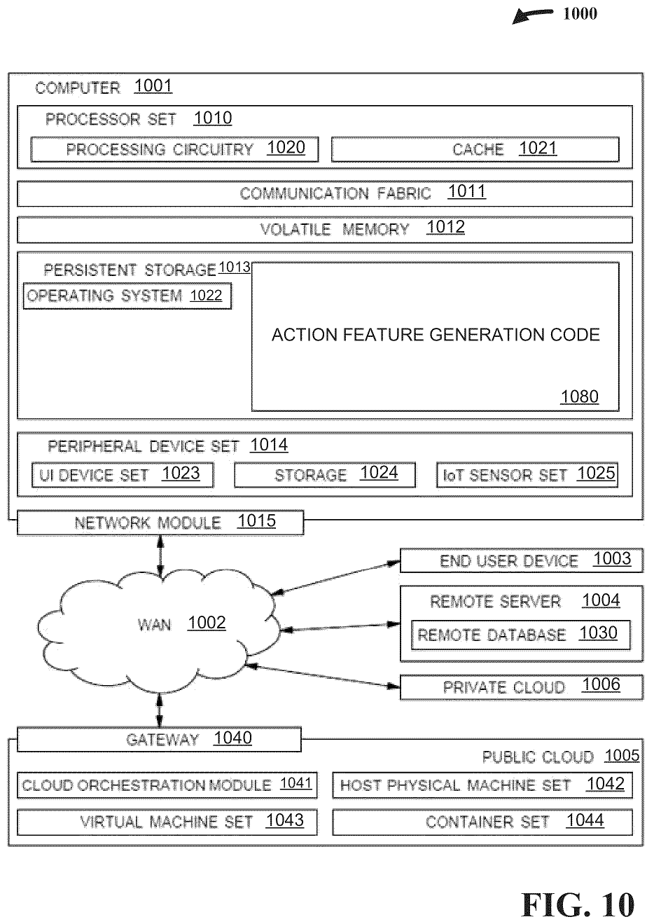

FIG. 10 and the following discussion are intended to provide a brief, general description of a suitable computing environment 1000 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as filling slots with action feature generation code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1014 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip. ” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1045 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer, and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to some embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
an analysis component that analyzes a policy document;
a policy dataframe component that generates a policy dataframe corresponding to attributes of the analyzed policy document;
an enforcement component that determines a set of tasks to be performed in order to ensure compliance with the policy document.

2. The system of claim 1, further comprising a performance component that performs the set of tasks; and a validation component that validates compliance with the policy.

3. The system of claim 1, wherein the attributes comprise at least one of: an area of focus of the policy, a scope of the policy, a summary of the policy, and specific requirements of the at least one policy.

4. The system of claim 1, wherein the policy dataframe component utilizes a large language model to identify the attributes.

5. The system of claim 1, further comprising a training component that trains an artificial intelligence model to automatically generate the policy data frame and automatically perform the set of tasks.

6. The system of claim 1, wherein the enforcement component ensures compliance by:
breaking down a final output, mapping the final output to the attributes, and assessing compliance with the policy.

7. The system of claim 1, further comprising an artificial intelligence component that trains a large language model to identify the attributes.

8. The system of claim 7, wherein the artificial intelligence component uses the attributes to assess policy compliance.

9. The system of claim 1, wherein, in response to a determination that performance of the set of tasks fails to result in policy compliance, the enforcement component identifies a new set of tasks to be performed in order to ensure policy compliance.

10. A computer-implemented method that utilizes a processor that executes computer executable components stored in memory to perform the following acts:
analyzing a policy document;
generating a policy dataframe corresponding to attributes of the analyzed policy document; and
determining a set of tasks to be performed in order to ensure compliance with the policy document.

11. The method of claim 10, further comprising performing the set of tasks; and validating compliance with the policy.

12. The method of claim 10, wherein the attributes comprise at least one of: an area of focus of the policy, a scope of the policy, a summary of the policy, and specific requirements of the at least one policy.

13. The method of claim 10, further comprising utilizing a large language model to identify the attributes.

14. The method of claim 10, further comprising training an artificial intelligence model to automatically generate the policy data frame and automatically perform the set of tasks.

15. The method of claim 10, further comprising: breaking down an at least one final output, mapping the at least one final output to the attributes, and assessing compliance with the at least one policy.

16. The method of claim 10, further comprising training a large language model to identify the attributes.

17. The method of claim 10, further comprising, determining that performance of the set of tasks fail to result in policy compliance.

18. The method of claim 17, further comprising identifying a new set of tasks to be performed in order to ensure policy compliance.

19. A computer program product comprising a computer readable storage medium having program instructions embodied therewith, the program instructions executable by a processor to cause the processor to:
analyze a policy document;
generate a policy dataframe corresponding to attributes of the analyzed policy document; and
determine a set of tasks to be performed in order to ensure compliance with the policy document.
